(19) United States
(12) Patent Application Publication
(10) Pub. No.: US 2013/0090889 A1
(43) Pub. Date: Apr. 11, 2013

(54) DYNAMIC REGULATION OF TEMPERATURE CHANGES USING TELEMETRY DATA ANALYSIS

(71) Applicants: Kalyanaraman Vaidyanathan, San Diego, CA (US); Kenny C. Gross, San Diego, CA (US); Aleksey M. Urmanov, San Diego, CA (US); David K. McElfresh, San Diego, CA (US)

(72) Inventors: Kalyanaraman Vaidyanathan, San Diego, CA (US); Kenny C. Gross, San Diego, CA (US); Aleksey M. Urmanov, San Diego, CA (US); David K. McElfresh, San Diego, CA (US)

(73) Assignee: Oracle International Corporation, Redwood Shores, CA (US)

(21) Appl. No.: 13/253,888

(22) Filed: Oct. 5, 2011

(51) Int. Cl. G01K 17/00

(52) U.S. Cl. 702/136

(57) ABSTRACT

The disclosed embodiments provide a system that analyzes telemetry data from a computer system. During operation, the system obtains the telemetry data as a set of telemetric signals using a set of sensors in the computer system. Next, the system uses a regularization technique to calculate a temperature derivative with respect to time for a component in the computer system from the telemetric signals. Finally, the system controls a subsequent value of the temperature derivative with respect to time by modulating a fan speed in the computer system based on the calculated temperature derivative with respect to time and the telemetric signals.

### BACKGROUND

1. Field

The present embodiments relate to techniques for monitoring and analyzing computer systems. More specifically, the present embodiments relate to a method and system for regulating the temperature derivative with respect to time within a computer system through analysis of telemetry data from the computer system.

2. Related Art

Components in a computer system commonly experience dynamic fluctuations in temperature during system operation. Such fluctuations may be caused by changes in load, fluctuations in ambient air temperature (e.g., from cycling of air conditioning in a data center), changes in fan speed, power cycling of the computer system's processors, and/or reconfiguration of the components in a way that affects air distribution patterns inside the computer system.

To ensure reliability, computer system designers typically qualify new components over an expected operational profile for the anticipated life of the computer system (e.g., 5 to 7 years). In addition, designers usually specify a maximum operating temperature for a given component, with some systems including shutdown actuators to prevent the components from exceeding maximum operating temperatures.

However, thermal cycling and/or fluctuations that remain within acceptable temperature ranges may decrease reliability by accelerating degradation in system components. For example, large swings in temperature may be caused by power cycling between cold shutdown and full-powered operation of a computer system. Such rapid changes in temperature may further lead to solder fatigue, interconnect fretting, differential thermal expansion between bonded materials that lead to delamination failures, thermal mismatches between mating surfaces, differences in the coefficients of thermal expansion between packaging materials, wirebond shear and flexure fatigue, microcrack initiation and propagation in ceramic materials, and/or repeated stress reversals in brackets (which can lead to dislocations, cracks, and eventual mechanical failures).

Hence, what is needed is a mechanism for mitigating temperature fluctuations and/or cycling in computer systems.

### SUMMARY

The disclosed embodiments provide a system that analyzes telemetry data from a computer system. During operation, the system obtains the telemetry data as a set of telemetric signals using a set of sensors in the computer system. Next, the system uses a regularization technique to calculate a temperature derivative with respect to time for a component in the computer system from the telemetric signals. Finally, the system controls a subsequent value of the temperature derivative with respect to time by modulating a fan speed in the computer system based on the calculated temperature derivative with respect to time and the telemetric signals.

In some embodiments, the system also validates the telemetric signals using a nonlinear, nonparametric regression technique.

In some embodiments, validating the telemetric signals involves verifying the operability of a set of temperature sensors and a set of fan speed sensors in the computer system using the telemetric signals.

In some embodiments, the regularization technique performs at least one of dequantizing the telemetric signals and removing noise from the telemetric signals.

In some embodiments, the regularization technique corresponds to Tikhonov regularization.

In some embodiments, controlling the subsequent value of the temperature derivative with respect to time involves capping the temperature derivative with respect to time at a pre-specified threshold.

In some embodiments, the pre-specified threshold is based on at least one of:

(i) a thermal inertia of the computer system;

(ii) a cooling efficiency of the computer system; and

(iii) an altitude of the computer system.

In some embodiments, the temperature derivative with respect to time is capped during at least one of powering on of the computer system and powering off of the computer system.

In some embodiments, the component is at least one of a processor, a power supply unit, a memory, and an integrated circuit.

### BRIEF DESCRIPTION OF THE FIGURES

FIG. 1 shows a computer system which includes a service processor for processing telemetry signals in accordance with an embodiment.

FIG. 2 shows a telemetry analysis system which examines both short-term real-time telemetry data and long-term historical telemetry data in accordance with an embodiment.

FIG. 3 shows a flowchart illustrating the process of analyzing telemetry data from a computer system in accordance with an embodiment.

FIG. 4 shows a computer system in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

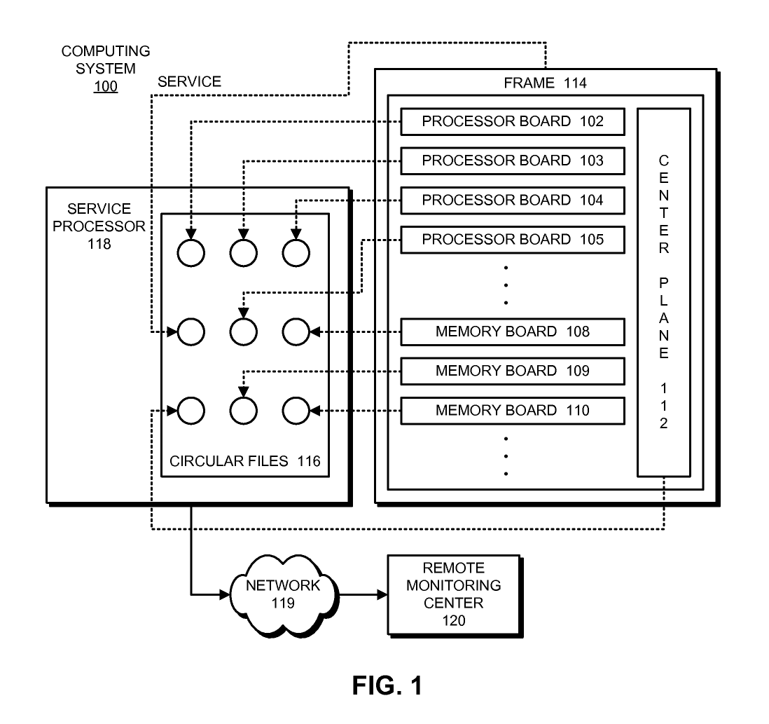

FIG. 1 shows a computer system which includes a service processor for processing telemetry signals in accordance with an embodiment. As is illustrated in FIG. 1, computer system 100 includes a number of processor boards 102-105 and a number of memory boards 108-110, which communicate with each other through center plane 112. These system components are all housed within a frame 114.

In one or more embodiments, these system components and frame 114 are all “field-replaceable units” (FRUs), which are independently monitored as is described below. Note that all major system units, including both hardware and software, can be decomposed into FRUs. For example, a software FRU can include an operating system, a middleware component, a database, and/or an application.

Computer system 100 is associated with a service processor 118, which can be located within computer system 100, or alternatively can be located in a standalone unit separate from computer system 100. For example, service processor 118 may correspond to a portable computing device, such as a mobile phone, laptop computer, personal digital assistant (PDA), and/or portable media player. Service processor 118 may include a monitoring mechanism that performs a number of diagnostic functions for computer system 100. One of these diagnostic functions involves recording performance parameters from the various FRUs within computer system 100 into a set of circular files 116 located within service processor 118. In one embodiment of the present invention, the performance parameters are recorded from telemetry signals generated from hardware sensors and software monitors within computer system 100. In one or more embodiments, a dedicated circular file is created and used for each FRU within computer system 100.

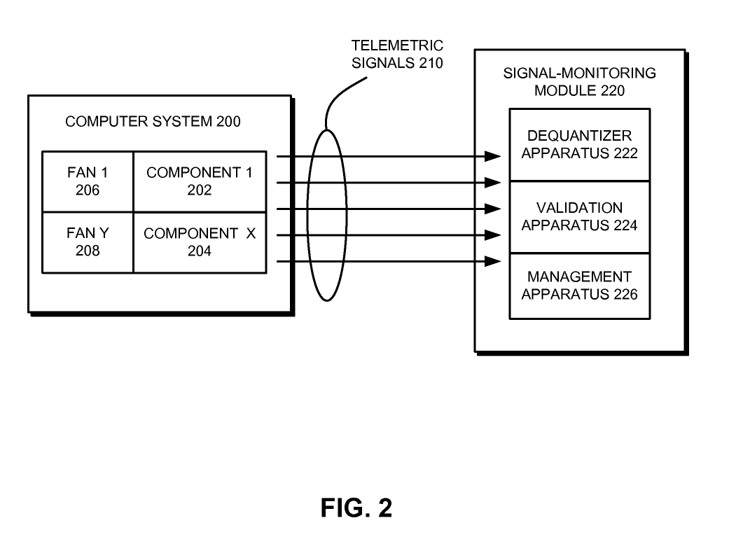

The contents of one or more of these circular files 116 can be transferred across network 119 to remote monitoring center 120 for diagnostic purposes. Network 119 can generally include any type of wired or wireless communication channel capable of coupling together computing nodes. This includes, but is not limited to, a local area network (LAN), a wide area network (WAN), a wireless network, and/or a combination of networks. In one or more embodiments, network 119 includes the Internet. Upon receiving one or more circular files 116, remote monitoring center 120 may perform various diagnostic functions on computer system 100, as described below with respect to FIG. 2. The system of FIG. 1 is described further in U.S. Pat. No. 7,020,802 (issued Mar. 28, 2006), by inventors Kenny C. Gross and Larry G. Votta, Jr., entitled “Method and Apparatus for Monitoring and Recording Computer System Performance Parameters,” which is incorporated herein by reference.

FIG. 2 shows a telemetry analysis system which examines both short-term real-time telemetry data and long-term historical telemetry data in accordance with an embodiment. In this example, a computer system 200 is monitored using a number of telemetric signals 210, which are transmitted to a signal-monitoring module 220. Signal-monitoring module 220 may assess the state of computer system 200 using telemetric signals 210. For example, signal-monitoring module 220 may analyze telemetric signals 210 to detect and manage faults in computer system 200 and/or issue alerts when there is an anomaly or degradation risk in computer system 200.

Signal-monitoring module 220 may be provided by and/or implemented using a service processor associated with computer system 200.

Alternatively, signal-monitoring module 220 may reside within a remote monitoring center (e.g., remote monitoring center 120 of FIG. 1) that obtains telemetric signals 210 from computer system 200 over a network connection. Regardless of location, signal-monitoring module 220 may be operated from a continuous power line that is not interrupted when computer system 200 is powered off.

Moreover, signal-monitoring module 220 may include functionality to analyze both real-time telemetric signals 210 and long-term historical telemetry data. For example, signal-monitoring module 220 may be used to detect anomalies in telemetric signals 210 received directly from one or more monitored computer system(s) (e.g., computer system 200). Signal-monitoring module 220 may also be used in offline detection of anomalies from the monitored computer system(s) by processing archived and/or compressed telemetry data associated with the monitored computer system(s).

Those skilled in the art will appreciate that temperatures within computer system 200 may fluctuate rapidly and/or frequently. For example, power cycling of computer system 200 may alternate between periods in which computer system 200 is powered on to process a workload and periods in which computer system 200 is powered off after workload processing is complete to conserve energy. Heat generated by components (e.g., component 1 202, component x 204) of computer system 200 during full-powered execution may sharply increase the temperatures within computer system 200, while the dissipation of the generated heat during the powered-off periods may quickly decrease the temperatures within computer system 200.

Such rapid changes in temperature (e.g., on the order of 50° C.) may subject the components to thermal shock, and in turn, adversely affect the reliability of computer system 200. For example, frequent large-amplitude fluctuations in temperatures within computer system 200 may increase degradation associated with solder fatigue, interconnect fretting, differential thermal expansion between bonded materials, thermal mismatches between mating surfaces, differentials in the coefficients of thermal expansion between materials in power supply unit internals, wirebond shear and flexure fatigue, microcrack initiation and propagation in ceramic components, and/or repeated stress reversals in brackets that lead to dislocations, cracks, and eventual mechanical failures.

At the same time, the effects of thermal shock in computer system 200 may be influenced by the configuration, workload, and/or environment of computer system 200. First, the temperature changes may be affected by the timing of changes in the speeds of cooling fans (e.g., fan 1 206, fan y 208) with respect to powering on and off of computer system 200. For example, continued running of cooling fans at full speed after components have stopped executing may result in rapid drops in the temperatures of the components. On the other hand, the stopping of cooling fans simultaneously with the components may produce a thermal spike in the components, followed by a gradual reduction in the components' temperatures. In both cases, temperatures may fluctuate at rates that subject the components to thermal shock.

Moreover, heat generated by components in computer system 200 may produce spatial temperature gradients that vary according to the dimensions of computer system 200 and/or the arrangement of components within computer system 200. For example, the thermal inertia of computer system 200 may increase with the mass of computer system 200 and/or decrease with the surface area of computer system 200. As a result, a 1U server may be associated with a greater susceptibility to thermal shock than that of a 2U server. Similarly, small components in computer system 200 may experience greater temperature fluctuations than large components in computer system 200.

Finally, the magnitude of temperature fluctuations within computer system 200 may be affected by environmental parameters. For example, cooling of computer system 200 may be more efficient at lower altitudes and/or ambient temperatures. Along the same lines, higher fan speeds and/or more efficient heat sinks may facilitate heat dissipation from components in computer system 200 but may also subject the components to cold shock if the fans continue running after the components have shut off.

In one or more embodiments, signal-monitoring module 220 includes functionality to dynamically assess and regulate temperature fluctuations in computer system 200 based on the workload, thermal characteristics, and/or environment of computer system 200. To enable thermal management of computer system 200, signal-monitoring module 220 may obtain telemetric signals 210 corresponding to temperature signals and/or fan speed signals using sensors in computer system 200. The temperature signals may be measured from processors, memory, power supplies, integrated circuits, and/or other components (e.g., component 1 202, component x 204) in computer system 200, while the fan speed signals may be measured from cooling fans (e.g., fan 1 206, fan y 208) in computer system 200.

Furthermore, a number of components in signal-monitoring module 220 may process and/or analyze telemetric signals 210. First, a dequantizer apparatus 222 may calculate a temperature derivative with respect to time for each component (e.g., processor, memory, integrated circuit, power supply unit, etc.) in computer system 200. To facilitate accurate calculation of the temperature derivative with respect to time, dequantizer apparatus 222 may use a regularization technique to dequantize and/or remove noise from telemetric signals 210. For example, dequantizer apparatus 222 may apply Tikhonov regularization during numerical differentiation of temperature signals from telemetric signals 210 to penalize irregularity in the temperature signals. Alternatively, dequantizer apparatus 222 may apply the regularization technique to the temperature signals before or after differentiation of the temperature signals. Use of Tikhonov regularization to remove quantization and/or noise in temperature signals is described further in U.S. Pat. No. 7,716,006 (issued 11 May 2010), by inventors Ayse K. Coskun, Aleksey M. Urmanov, Kenny C. Gross, and Keith A. Whisnant, entitled “Workload Scheduling in Multi-Core Processors,” which is incorporated herein by reference.

Next, a validation apparatus 224 may validate the temperature signals using a nonlinear, nonparametric regression technique. The validation may compare the dequantized temperature signals with fan speed signals from telemetric signals 210 to verify that temperature sensors and/or fan speed sensors in computer system 200 are operable. For example, validation apparatus 224 may verify that the temperature and/or fan speed sensors have not degraded and/or drifted out of calibration using the temperature and fan speed signals.

In one or more embodiments, the nonlinear, nonparametric regression technique used by validation apparatus 224 corresponds to a multivariate state estimation technique (MSET). Validation apparatus 224 may be trained using historical telemetry data from computer system 200 and/or similar computer systems. The historical telemetry data may be used to determine correlations among various telemetric signals 210 collected from the monitored computer system(s) and to enable accurate verification of various real-time telemetric signals 210 (e.g., temperature and fan speed signals).

To validate telemetric signals 210 using MSET, validation apparatus 224 may generate estimates of telemetric signals 210 based on the current set of telemetric signals 210. Next, validation apparatus 224 may obtain residuals by subtracting the estimated telemetric signals from the measured telemetric signals 210. The residuals may represent the deviation of computer system 200 from known operating configurations of computer system 200. As a result, validation apparatus 224 may validate telemetric signals 210 by analyzing the residuals over time, with changes in the residuals representing degradation and/or decalibration drift in the sensors.

For example, validation apparatus 224 may use MSET to generate, from telemetric signals 210, 16 possible combinations of temperatures and fan speeds in computer system 200. Validation apparatus 224 may also calculate 16 sets of residuals by subtracting telemetric signals 210 from each set of estimated telemetric signals. Because telemetric signals 210 should correspond to one of the 16 possible configurations in computer system 200, one set of residuals should be consistent with normal signal behavior in the corresponding configuration (e.g., normally distributed with a mean of 0). On the other hand, the other 15 sets of residuals may indicate abnormal signal behavior (e.g., nonzero mean, higher or lower variance, etc.) because telemetric signals 210 do not match the estimated (e.g., characteristic) telemetric signals for the remaining combinations of processor states. Moreover, if abnormal signal behavior is found in all 16 sets of residuals, degradation and/or decalibration drift may be present in one or more sensors. Consequently, the temperature and/or fan speed signals may be valid if one set of residuals represents normal signal behavior and invalid if none of the residuals represents normal signal behavior.

In one or more embodiments, the nonlinear, nonparametric regression technique used in validation apparatus 224 may refer to any number of pattern-recognition algorithms. For example, see [Gribok] “Use of Kernel Based Techniques for Sensor Validation in Nuclear Power Plants,” by Andrei V. Gribok, J. Wesley Hines, and Robert E. Uhrig, The Third American Nuclear Society International Topical Meeting on Nuclear Plant Instrumentation and Control and Human-Machine Interface Technologies, Washington D.C., Nov. 13-17, 2000. This paper outlines several different pattern-recognition approaches. Hence, the term “MSET” as used in this specification can refer to (among other things) any of 25 techniques outlined in [Gribok], including Ordinary Least Squares (OLS), Support Vector Machines (SVM), Artificial Neural Networks (ANNs), MSET, or Regularized MSET (RMSET).

After the temperature derivative with respect to time is calculated and/or the temperature signals have been validated, a management apparatus 226 in signal-monitoring module 220 may control a subsequent value of the temperature derivative with respect to time by modulating a fan speed in computer system 200 based on the calculated temperature derivative with respect to time and/or telemetric signals 210. For example, validation apparatus 224 may identify the components with the highest temperatures and/or temperature derivative with respect to times in computer system 200. Management apparatus 226 may then modulate the fan speeds of one or more fans (e.g., fan 1 206, fan y 208) in computer system 200 based on the temperatures and/or temperature derivative with respect to times so that the temperatures and/or temperature derivative with respect to times do not exceed a pre-specified threshold for computer system 200 (e.g., during powering on and/or powering off of computer system 200). For example, if a processor's temperature decreases at a rate that approaches the threshold during powering off of computer system 200, management apparatus 226 may reduce the fan speed of the processor's cooling fan to slow the rate of cooling of the processor and mitigate degradation caused by thermal stress on the processor.

In one or more embodiments, the pre-specified threshold at which temperature derivative with respect to times in computer system 200 are capped is based on a thermal inertia of computer system 200, a cooling efficiency of computer system 200, and/or an altitude of computer system 200. For example, validation apparatus 224 may monitor temperatures and/or temperature fluctuations in components of computer system 200 during powering on, full-powered execution, and/or powering off of computer system 200. Next, validation apparatus 224 and/or management apparatus 226 may use the monitored temperatures and/or fluctuations to assess the thermal inertia, cooling efficiency (e.g., from fans, heat sinks, and/or air conditioning), and/or altitude of computer system 200, and in turn, set the threshold for capping temperature derivative with respect to times in computer system 200. Management apparatus 226 may then use the assessed characteristics and threshold to control fan speeds within computer system 200 in a way that reduces thermal stress on the components of computer system 200.

Because signal-monitoring module 220 may use a regularization technique to dequantize and/or remove noise from telemetric signals 210 and a nonlinear, nonparametric regression technique to validate telemetric signals 210, signal-monitoring module 220 may facilitate the accurate assessment of temperature derivative with respect to times and/or the thermal state of computer system 200 from telemetric signals 210. In addition, the control of temperature fluctuations using both the temperature derivative with respect to times and the thermal characteristics of computer system 200 may mitigate thermal stress in computer system 200 for a variety of workloads, environments, and/or configurations associated with computer system 200. For example, signal-monitoring module 220 may be configured to control temperature fluctuations in a water-cooled computer system by increasing or decreasing the circulation of cooling water in the vicinity of the computer system. Finally, the reduction of thermal stress in processors, memory, power supply units, integrated circuits, and/or other components of computer system 200 may decrease degradation in computer system 200, thereby increasing the long-term reliability of computer system 200.

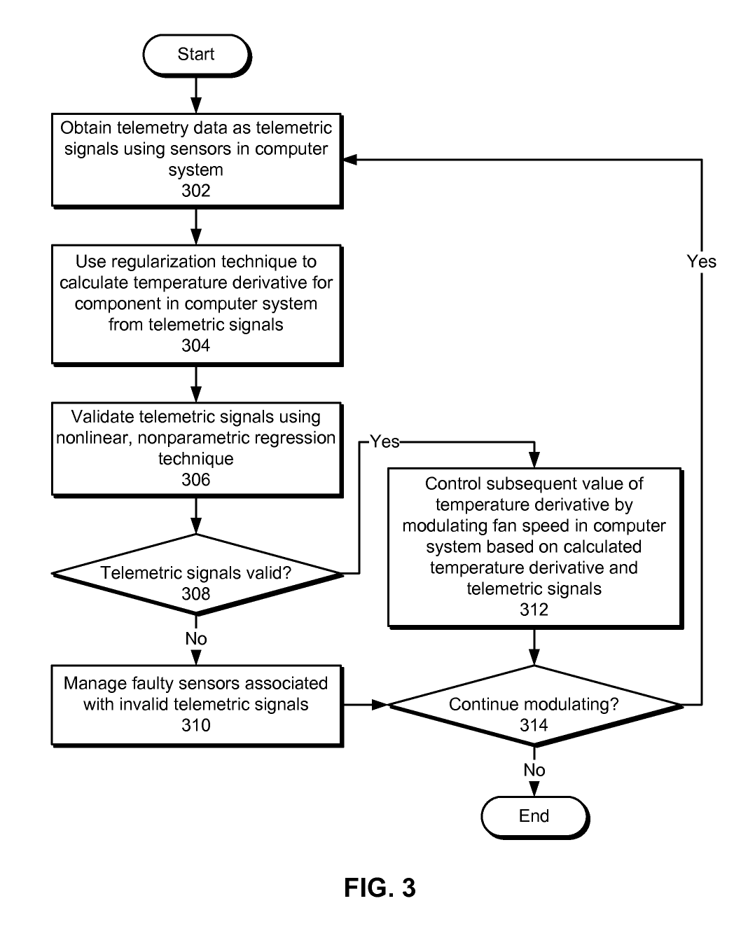

FIG. 3 shows a flowchart illustrating the process of analyzing telemetry data from a computer system in accordance with an embodiment. In one or more embodiments, one or more of the steps may be omitted, repeated, and/or performed in a different order. Accordingly, the specific arrangement of steps shown in FIG. 3 should not be construed as limiting the scope of the technique.

Initially, the telemetry data is obtained as a set of telemetric signals using a set of sensors in the computer system (operation 302). The telemetric signals may include temperature signals and fan speed signals. Next, a regularization technique is used to calculate a temperature derivative with respect to time for a component in the computer system from the telemetric signals (operation 304). The regularization technique may dequantize the telemetric signals and/or remove noise from the telemetric signals. For example, Tikhonov regularization may be used to accurately calculate a temperature derivative with respect to time for each processor, power supply unit, memory, and/or integrated circuit in the computer system.

The telemetric signals may also be validated using a nonlinear, nonparametric regression technique (operation 306). For example, the temperature and fan speed signals may be processed using MSET to verify the operability of a set of temperature sensors and a set of fan speed sensors in the computer system.

Analysis of the telemetric signals may proceed based on the validity of the telemetric signals (operation 308). If the telemetric signals are invalid, a set of faulty sensors associated with the invalid telemetric signals is managed (operation 310). For example, if a faulty temperature sensor is causing cooling fans to continuously cycle between low and high speeds, a series of replacement temperature values may be generated to maintain normal fan speeds prior to the replacement of the faulty temperature sensor. The replacement of the faulty sensors may also be facilitated by notifying a technician of the faulty sensors.

If the telemetric signals are valid, a subsequent value of the temperature derivative with respect to time is controlled by modulating a fan speed in the computer system based on the calculated temperature derivative with respect to time and the telemetric signals (operation 312). In particular, the temperature derivative with respect to time may be capped at a pre-specified threshold to avert degradation caused by thermal stress on the computer system. The pre-specified threshold may be based on a thermal inertia of the computer system, a cooling efficiency of the computer system, and/or an altitude of the computer system. In addition, the temperature derivative with respect to time may be capped during powering on and/or off of the computer system. For example, if the calculated temperature derivative with respect to time approaches the threshold during powering on of the computer system, subsequent values of the temperature derivative with respect to time may be reduced by increasing one or more fan speeds in the computer system.

Management of temperature derivative with respect to times may continue (operation 314) in a feedback loop as long as temperature fluctuations are to be managed in the computer system. For example, the temperature derivative with respect to times may continue to be controlled during use of the computer system to decrease degradation in the components and increase the long-term reliability of the computer system. Consequently, telemetry data may be continuously obtained (operation 302), used to calculate a temperature derivative with respect to time (operation 304), and validated (operations 306-310), and the calculated temperature derivative with respect to time and validated telemetric signals may be used to control subsequent values of the temperature derivative with respect to time (operation 312) during the lifetime of the computer system.

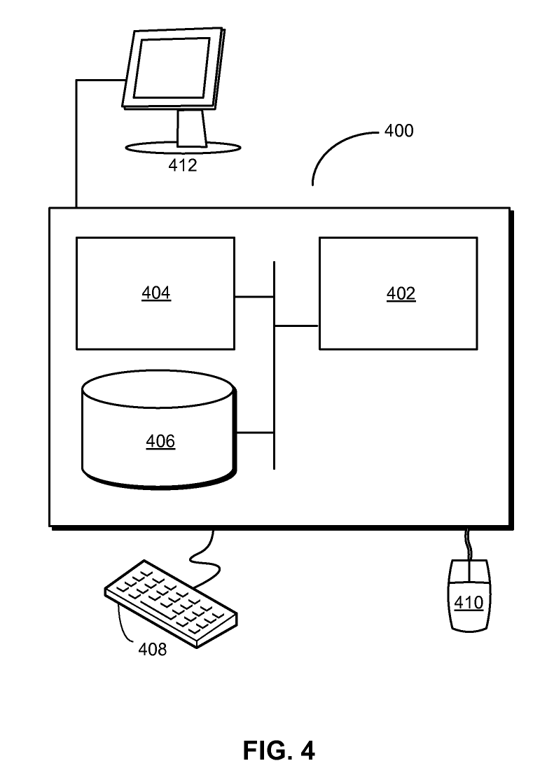

FIG. 4 shows a computer system 400 in accordance with an embodiment. Computer system 400 includes a processor 402, memory 404, storage 406, and/or other components found in electronic computing devices.

Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 may provide a system that analyzes telemetry data from a computer system. The system may include a monitoring mechanism that obtains the telemetry data as a set of telemetric signals using a set of sensors in the computer system. The system may also include a signal-monitoring module that uses a regularization technique to calculate a temperature derivative with respect to time for a component in the computer system from the telemetric signals. The signal-monitoring module may also validate the telemetric signals using a nonlinear, nonparametric regression technique. Finally, the signal-monitoring module may control a subsequent value of the temperature derivative with respect to time by modulating a fan speed in the computer system based on the calculated temperature derivative with respect to time and the telemetric signals.

In addition, one or more components of computer system 400 may be remotely located and connected to the other components over a network. Portions of the present embodiments (e.g., monitoring mechanism, signal-monitoring module, etc.) may also be located on different nodes of a distributed system that implements the embodiments. For example, the present embodiments may be implemented using a cloud computing system that remotely manages the development, compilation, and execution of software programs.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for adjusting a fan speed in a computer system, comprising:
obtaining the telemetry data using a set of sensors in the computer system;
using a technique to calculate a temperature derivative with respect to time for a component in the computer system from the telemetrydata; and
controlling a subsequent value of the temperature derivative with respect to time by regulating a fan speed in the computer system based on the calculated temperature derivative with respect to time and the telemetry data.

2. The computer-implemented method of claim 1, further comprising:
validating the telemetry data using a nonlinear, nonparametric regression technique.

3. (Currrently Amended) The computer-implemented method of claim 2, wherein validating the telemetry data involves:
verifying the operability of a set of temperature sensors and a set of fan speed sensors in the computer system using the telemetry data.

4. The computer-implemented method of claim 1, wherein the technique comprises at least one of:
dequantizing the telemetry data; and
removing noise from the telemetry data.

5. The computer-implemented method of claim 1, wherein the technique corresponds to Tikhonov regularization.

6. The computer-implemented method of claim 1, wherein controlling the subsequent value of the temperature derivative with respect to time involves:
capping the temperature derivative with respect to time at a pre-specified threshold.

7. The computer-implemented method of claim 6, wherein the pre-specified threshold is based on at least one of:
a thermal inertia of the computer system;
a cooling efficiency of the computer system; and
an altitude of the computer system.

8. The computer-implemented method of claim 6, wherein the temperature derivative with respect to time is capped during at least one of:
powering on of the computer system; and
powering off of the computer system.

9. The computer-implemented method of claim 1, wherein the component is at least one of a processor, a power supply unit, a memory, and an integrated circuit.

10. A system for adjusting a fan speed in a computer system, comprising:
a monitoring mechanism configured to obtain the telemetry data using a set of sensors in the computer system; and
a signal-monitoring module configured to:
use a technique to calculate a temperature derivative with respect to time for a component in the computer system from the elemetry data; and
control a subsequent value of the temperature derivative with respect to time by regulating a fan speed in the computer system based on the calculated temperature derivative with respect to time and the elemetry data.

11. (Currrently Amended) The system of claim 10, wherein the signal-monitoring module is further configured to:
validate the elemetry data using a nonlinear, nonparametric regression technique.

12. (Currrently Amended) The system of claim 10, wherein the technique comprises at least one of:
dequantizing the elemetry data; and
removing noise from the elemetry data.

13. The system of claim 10, wherein controlling the subsequent value of the temperature derivative with respect to time involves:
capping the temperature derivative with respect to time at a pre-specified threshold.

14. The system of claim 13, wherein the pre-specified threshold is based on at least one of:
a thermal inertia of the computer system;
a cooling efficiency of the computer system; and
an altitude of the computer system.

15. The system of claim 10, wherein the component is at least one of a processor, a power supply unit, a memory, and an integrated circuit.

16. A computer-readable storage medium storing instructions that when executed by a computer cause the computer to adjust a fan speed in a computer system, the method comprising:
obtaining the telemetry data using a set of sensors in the computer system;
using a technique to calculate a temperature derivative with respect to time for a component in the computer system from the elemetry data; and
controlling a subsequent value of the temperature derivative with respect to time by regulating a fan speed in the computer system based on the calculated temperature derivative with respect to time and the signalstelemetry data.

17. The computer-readable storage medium of claim 16, the method further comprising:
validating the telemetry data using a nonlinear, nonparametric regression technique.

18. The computer-readable storage medium of claim 16, wherein the technique comprises at least one of:
dequantizing the telemetry data; and
removing noise from the telemetric signalstelemetry data.

19. The computer-readable storage medium of claim 16, wherein controlling the subsequent value of the temperature derivative with respect to time involves:
capping the temperature derivative with respect to time at a pre-specified threshold.

20. The computer-readable storage medium of claim 19, wherein the temperature derivative with respect to time is capped during at least one of:
powering on of the computer system; and
powering off of the computer system.
